(19) United States
(12) Patent Application Publication
(10) Pub. No.: US 2023/0077349 A1
(43) Pub. Date: Mar. 16, 2023

(54) SEED COATING ADDITIVE

(71) Applicant: Croda International Plc, Goole, East Yorkshire (GB)

(72) Inventors: Barry Johannes Hoff, Goole, East Yorkshire (GB); Marta Edyta Dobrowolska, Goole, East Yorkshire (GB)

(73) Assignee: Croda International Plc, Goole, East Yorkshire (GB)

(21) Appl. No.: 17/799,161

(22) PCT Filed: Feb. 15, 2021
(86) PCT No.: PCT/EP2021/053666

§ 371 Date: Aug. 11, 2022

(30) Foreign Application Priority Data
Feb. 14, 2020 (GB) 2002061.6

(51) Int. Cl. A01C 1/06; C09D 189/00

(52) U.S. Cl. CPC A01C 1/06; C09D 189/00

(57) ABSTRACT

A seed coating composition for coating plant seeds. The coating composition comprises a polymeric binder and/or resin, and a hydrolysed protein. The seed coating composition optionally comprises an agrochemical active and/or nutrient, and the composition is used to improve the seed's physical qualities, especially the seed's ability to resist drought or poor water conditions and/or high salinity conditions. There is also provided a method of making the formulations, and for treating seeds or bulbs with seed coating formulation.

The present invention relates to a seed coating composition, to a method of forming a seed coating composition and coating on to a seed, and to a coated seed, for use in coating seeds to maintain and improve drought resistance and salinity resistance of the seed and plant germinating therefrom.

Plant seed is often coated before sowing, for example, to protect seeds from damage during handling and/or to improve handling properties. Seeds are often coated to provide useful substances (active ingredients) to the seed and the seedlings upon germination, for example, plant nutrients, growth stimulating agents, and plant protective products. Typical seed coating methods include film coating, pelleting and encrusting of seed.

The present invention seeks to provide a seed coating composition, where the composition provides desired drought resistance and salinity resistance to a seed coated with said formulation and to a plant formed from a coated seed.

According to a first aspect of the present invention there is provided a seed coating composition comprising a polymeric binder and/or resin, and a hydrolysed protein.

According to a second aspect of the present invention there is provided a method of forming a seed coating composition which comprises combining an aqueous composition pre-blend comprising a polymeric binder and/or resin, and a hydrolysed protein pre-blend.

According to a third aspect of the present invention there is provided a method of coating seed which comprises applying a seed coating composition comprising a polymeric binder and/or resin, and a hydrolysed protein, to a seed.

According to a fourth aspect of the invention, there is provided a seed with a coating comprising polymeric binder and/or resin, and a hydrolysed protein.

According to a fifth aspect of the invention, there is provided the use of a seed coating composition comprising polymeric binder and/or resin, and a hydrolysed protein for increasing drought and salinity resistance of a seed coated with said composition.

According to a sixth aspect of the invention, there is provided the use of a seed coating composition comprising polymeric binder and/or resin, and a hydrolysed protein for increasing drought and salinity resistance of a plant formed from a seed coated with said composition.

According to a seventh aspect of the present invention there is provided a two component system comprising a first component being a polymeric binder and/or resin, and a second component being a hydrolysed protein, suitable for combining to form a seed coating composition in accordance with the first aspect.

The seed coating composition of the present invention may be used to improve the seed's physical qualities, especially the seed's ability to resist drought or poor water conditions and/or high salinity conditions. The advantageous properties are found to be present for the seed coating with the composition, and for a plant formed from a coated seed.

As used herein, the terms “for example,” “for instance,” “such as,” or “including” are meant to introduce examples that further clarify more general subject matter. Unless otherwise specified, these examples are provided only as an aid for understanding the applications illustrated in the present disclosure, and are not meant to be limiting in any fashion.

The term “seed” as used in this application is meant to refer in particular to the ripened ovule of gymnosperms and angiosperms, which contain an embryo surrounded by a protective cover. In particular, the term covers field crop seeds, vegetable seeds, and cereal kernels. The protective cover can comprise the seed coat (testa). Some seeds comprise a pericarp or fruit coat around the seed coat. As used in this application, the term “seed coat” is meant to include a caryopsis or an achene.

The term “seed” includes anything that can be planted in agriculture to produce plants, including pelleted seeds, true seeds, plant seedlings, rootstock, regenerable and plant forming tissue, and tubers or bulbs.

The term “coating” as used in this application, is meant to refer to applying material to a surface of a seed, for instance as a layer of a material around a seed. Coating includes film coating, pelleting, and encrusting or a combination of these techniques as known in the art. The coating is preferably applied over substantially the entire surface of the seed, such as over 90% or more of the surface area of the seed, to form a layer. However, the coating may be complete or partial, for instance over 20% or more of the surface area of the seed, or 50% or more.

The term “seed coating composition” as used in this application is meant to refer to a composition to be used for coating of seed.

The term “drought stress” as used in this application is meant to refer to stress that occurs as a result of non-living factors influencing the environment in which the plant lives, and in particular drought and osmotic stress. The term “salinity stress” would similarly relate to the stress resulting on the plant due to high levels of salts in the surrounding soil and environment. The “tolerance” of the plant refers to the ability of a plant to endure said stresses without suffering a substantial alteration in metabolism, growth, productivity and/or viability.

The seed is a plant seed, for example a seed of an agricultural or field crop, a vegetable seed, a herb seed, a wildflower seed, an ornamental seed, a grass seed, a tree seed, or a bush seed.

Preferably, the plant seed is of an agricultural crop. The seed may be of the order of Monocotyledoneae or of the order of Dicotyledoneae. Suitable seeds include seed of soybean, cotton, corn, peanut, maize, wheat, barley, oat, rye triticale, mustard, oil seed rape (or canola) sunflower, sugar beet, safflower, millet, chicory, flax, rapeseed, buckwheat, tobacco, hemp seed, alfalfa, signal grass, clover, sorghum, chick pea, beans, peas, vetch, rice, sugar cane, guayule, and linseed. Examples of suitable vegetable seeds include asparagus, chives, celery, leek, garlic, beetroot, spinach, beet, curly kale, cauliflower, sprouting broccoli, savoy cabbage, white cabbage, red cabbage, kohlrabi, Chinese cabbage, turnip, endive, chicory, water melon, melon, cucumber, gherkin, marrow, parsley, fennel, pea, beans, radish, black salsify, eggplant, sweet corn, pop-corn, carrot, onion, tomato, pepper, lettuce, snap bean, cucurbit, shallot, broccoli, Brassica, and Brussels sprout.

Preferably, the plant seed is selected from the group consisting of corn, sunflower, wheat, lettuce, and onions, and particularly is corn.

Preferably, the plant seed is capable of germinating. Optionally, the seed may be deprived of husk (so called husked seed or de hulled seed).

The term “hydrolysed protein” is used herein to include polypeptides, peptides, amino acids and/or peptones. Polypeptides, peptides and amino acids may, for example, be produced by acid, alkali and/or enzyme hydrolysis, of native proteins. Enzyme hydrolysed proteins are preferred. In one embodiment, hydrolysed wheat proteins are preferred, in particular produced by enzyme hydrolysis. The hydrolysed protein component may also contain starch, for example hydrolysed wheat protein may contain wheat starch.

The hydrolysed protein may be formed from individual amino acids, or from amino acids comprised within longer peptide chains that are derived from hydrolysed protein. Preferably the hydrolysed protein may be amino acids chain formed from hydrolysing a protein.

The hydrolysed protein present in the seed treatment composition used in the present invention may be derived from either animal or vegetable sources, or by fermentation. Examples of suitable proteins include collagen, elastin, keratin, casein, wheat protein, wheat starch, potato protein, soya protein and/or silk protein. Wheat protein and/or potato protein are particularly preferred, and especially wheat protein.

The hydrolysed protein may also be chemically modified, for example where the protein has been covalently reacted with a functional group, e.g. a silane, a quaternary ammonium compound and/or an acid chloride.

The term “protein” is used herein to include both native (or chemically unmodified) and hydrolysed proteins, and thus comprises proteins properly so-called and polypeptides, peptides, amino acids and/or peptones, since the latter can all be categorised as hydrolysed proteins. Hydrolysed proteins are preferred, particularly polypeptides and peptides, which may for example be produced by acid, alkali, and/or enzyme hydrolysis, of native proteins. Acid hydrolysed proteins are preferred. In one embodiment, hydrolysed keratin proteins are preferred, in particular produced by acid hydrolysis.

Chemically modified proteins and/or hydrolysed proteins may also be employed, for example where the protein has been covalently reacted with a functional group, e.g. a silane, a quaternary ammonium compound and/or an acid chloride.

It will be understood that the protein component is a mixture of amino acids and short protein chains, small peptides.

The molecular weight (weight average) of the protein component starting material (prior to hydrolysis) may vary over a wide range, such as for example in the range from 100 to 500,000 Daltons. Molecular weight average will be understood to be a measurement of the value across the whole range of amino acid comprising compounds in the seed coating composition.

The molecular weight (weight average) of the hydrolysed protein may vary over a wide range, such as for example in the range from 50 Da to 50,000 Da, preferably 100 Da to 5,000 Da, more preferably 150 Da to 1500 Da. In one embodiment, the hydrolysed protein may have an average molecular weight in the range from 500 Da to 2,500 Da, preferably 1,000 Da to 2,000 Da, in particular 1,250 Da to 1,750 Da, for example about 1,500 Da. In a further embodiment, the hydrolysed protein may have an average molecular weight in the range from 50 Da to 250 Da, preferably 100 Da to 200 Da, in particular about 150 Da.

In one embodiment, the individual hydrolysed protein segments may comprise on average in the range from 1.5 to 200, preferably 5 to 100, more preferably 8 to 50, particularly 10 to 25 amino acids. In a further embodiment, the individual hydrolysed protein segments may comprise on average in the range from 1 to 10, preferably 1 to 5, more preferably 1 to 3, particularly 1 to 2 amino acids.

The hydrolysis performed will be to the extent required to achieve the desired molecular weight and chain length of the hydrolysed protein. The degree of hydrolysis may be varied by varying the temperature, pH, concentration and type of enzyme used, and time taken.

The hydrolysed protein may be filtered and treated to remove undesired material.

Once hydrolysed, the protein or polypeptide comprises on average in the range from 2 to 15, preferably 4 to 12, more preferably 6 to 10 amino acids.

It is preferred that the hydrolysed protein component is capable of forming a solution in water.

Preferably where the amount of free amino acid in the hydrolysed protein is less than 60 wt. %. More preferably less than 55 wt. %. It will be understood that as the free amino acid has low solubility it is desired that the amount is at a low level.

One or more polymeric binders are present in the seed coating composition of the present invention. The at least one polymeric binder is preferably an organic polymeric binder, more preferably a synthetic polymeric binder. The polymeric binder may, for example, be selected from the group consisting of polyvinyl acetates, polyvinyl acetate copolymers, polyvinyl alcohols, polyvinyl alcohol copolymers, polyurethane, celluloses (including ethylcelluloses, methylcelluloses, hydroxymethylcelluloses, hydroxypropylcelluloses, carboxymethylcelluloses, and hydroxymethylpropyl celluloses), polyvinylpyrrolidones, dextrins, maltodextrins, starchs, polysaccharides, fats, oils, proteins, gum arabics, shellacs, vinylidene chloride, vinylidene chloride copolymers, calcium lignosulphonates, polyacrylates, acrylic copolymers, polyvinylacrylates, zeins, casein, gelatine, chitosan, pullulan, polyethylene oxide, polyethylene glycol, acrylamide polymers, acrylamide copolymers, polyhydroxyethyl acrylate, methylacrylamide polymers, poly(N vinylacetamide), sodium alginate, polychloroprene and syrups. These binders may be used alone or in combination of two, or three, or more.

Preferred binders can be selected from the group consisting of polyvinyl acetates, polyvinyl alcohols, hydroxypropylmethylcellulose, polysaccharides (other than starch), proteins, polyethylene glycol, polyvinyl pyrrolidones, and polyacrylates.

The binders used herein suitably has a molecular weight (weight average) in the range from 1,000 to 40,000, preferably 5,000 to 20,000, more preferably 9,000 to 11,000, particularly 9,500 to 10,500, and especially 9,800 to 10,200.

Preferable polymeric binders are copolymers of acrylic acid with alkyl methacrylates or styrene with molecular weights of less than 20,000, and a T_{g} of more than 30° C.

The acid based monomers of the polymeric binder may be selected from the broad groups of monomers which contain an acid such as carboxylic acid monomers, sulphonic acid monomers and phosphonic acid derivatives. The selection of monomer enables the polymer to be water soluble when in neutralised form and when copolymerised with hydrophobic monomers.

The polymeric binder may have a weight ratio of carboxylic acid to hydrophobe of 10-90:90-10, preferably 12-50:50-88, more preferably 15-40:85-60, and most preferably 20-30:80-70.

The acid based monomers of the polymeric binder may be selected from monomers of acrylic acid, methacrylic acid, itaconic acid, maleic acid, crotonic acid, sulphate acid derivatives of (meth)acrylic acid, sulphonic acid monomers such as AMPS, styrene sulphonic acid, vinyl sulphonic acid, allyl sulphonic acid, phosphonic acid derivatives such as vinyl phosphonic acid, or a mixture thereof. Preferably, acrylic acid, or methacrylic acid. More preferably, the monomer is methacrylic acid.

In an alternative embodiment the polymeric binder may be a homopolymer of polyvinyl alcohol (PVA), and said homopolymer may be hydrolysed at more than 70%.

The hydrophobe monomer may be vinyl monomer or vinyl aromatic monomer. Alternatively, the vinyl aromatic monomer may be replaced by other suitable monomers such as methyl methacrylate or other suitable alternatives.

Suitable vinyl aromatic monomers may preferably comprise from 8 to 20 carbon atoms, most preferably from 8 to 14 carbon atoms. Examples of vinyl aromatic monomers are styrene including substituted styrene, 1-vinyl naphthalene, 2-vinyl naphthalene, 3-methyl styrene, 4-propyl styrene, t-butyl styrene, 4-cyclohexyl styrene, 4-dodecyl styrene, 2-ethyl-4-benzyl styrene, 4-(phenylbutyl) styrene, alpha-methylstyrene, and halogenated styrenes.

The vinyl aromatic monomer(s) can be, and desirably is, styrene as such or a substituted styrene particularly a hydrocarbyl, desirably alkyl, substituted styrene, in which the substituent(s) are on the vinyl group or on the aromatic ring of the styrene e.g. α-methyl styrene and vinyl toluene.

The styrene monomer can be or include styrene monomers including strongly acid, particularly sulphonic acid substituents. When present such strong acid modified monomers usually form from 1 to 30 mol. %, more usually 2 to 20 mol. %, and desirably from 5 to 15 mol. %, of the styrene monomers in the copolymer.

Preferably the vinyl aromatic monomer is styrene, α-methyl styrene, or a combination thereof.

Where the vinyl aromatic monomer is a mixture of styrene and a substituted styrene the monomer mixture may comprise in the range from 80-95 wt. % styrene and 5-20 wt. % substituted styrene.

Preferably the polymeric binder may be a styrene (meth)acrylic acid copolymer. The repeating units in the copolymer are conveniently considered as residues of monomer components.

In the water dispersible styrene (meth)acrylic copolymer used in the invention, the molar ratio of residues of the (meth)acrylic acid monomer(s) to those of the styrene monomer(s) is generally from 20:1 to 1:5, more usually 10:1 to 1:2 and particularly from 3:1 to 1:1.

Generally correspondingly, the proportions of residues of the monomers by weight are typically from 93 wt. % to 10 wt. %, more usually 87 wt. % to 25 wt. %, particularly 67 wt. % to 40 wt. %, of the (meth)acrylic acid monomer(s) and from 7 wt. % to 90 wt. %, more usually 13 wt. % to 75 wt. %, particularly 33 wt. % to 60 wt. %, of the styrene monomer(s).

The (meth)acrylic acid monomer(s) can comprise further monomers which are derivatives of (meth)acrylic acid. The derivatives of (meth)acrylic acid may include strong acid, and especially strong acids comprising sulphate acid or sulphonic acid groups (or their salts). Examples of such monomers include acrylamido methyl propyl sulphonate (AMPS) and (meth)acrylic acid isethionate.

When present such strong acid modified monomers usually form from 1 to 30 mol. %, more usually 2 to 20 mol. %, and desirably from 5 to 15 mol. %, of the acrylic acid monomers in the copolymer.

Other monomers, such as acidic monomers e.g. itaconic acid or maleic acid or anhydride; strongly acidic monomers such as methallyl sulphonic acid (or a salt); or non-acidic acrylic monomers e.g. acrylic esters which may be alkyl esters particularly C₁ to C₆ alkyl esters such as methyl methacrylate, butyl methacrylate or butyl acrylate or hydroxy alkyl esters particularly C₁ to C₆ hydroxyalkyl esters such as hydroxy ethyl methacrylate, or hydroxy propyl methacrylate; or vinyl monomers such as vinyl acetate, can be included. The proportion by weight of other monomers will typically be not more than about 30 wt. %, usually not more than about 20 wt. %, more usually not more than about 10 wt. %.

The polymer can be a single styrene acrylic acid copolymer or a blend including two or more such copolymers. In particular, when strong acid residues are included in the polymeric dispersant, the dispersant can be a blend of copolymer including strong acid residues and copolymer not including such residues. In such blends, it is generally desirable that the ratio of such copolymers is from 1:10 to 10:1, more usually 5:1 to 1:5, by weight. In particular, the proportion of copolymer including strong acid residues is desirably at least 25%, more usually at least 40%, by weight of the polymer.

The inclusion of monomers having strongly acidic substituent groups in the polymeric dispersant can provide improved dispersion of solid components in formulation such as solid granular agrochemical actives.

The polymer can be used as the free acid or as a salt. In practice, the form present in a formulation will be determined by the acidity of the formulation. Desirably, the formulation will be near neutral and so most of the acid groups will be present as salts. The cations in any such salt can be alkali metal, particularly sodium and/or potassium, ammonium, or amine, including alkanolamine such as ethanolamine, particularly tri-ethanolamine. In particular, sodium or potassium salts forms of the stabiliser polymer are preferred.

The neutralisation with at least 80% sodium is preferred, preferably 90%, most preferably greater than 95%.

The polymer used in the formulation of the invention may be wholly of styrene (meth)acrylic copolymers or it may include other dispersant materials such as the conventional dispersants mentioned above, such as naphthalene sulphonate formaldehyde condensates, lignosulphonates, maleic anhydride copolymers and condensed phenolsulphonic acid and their salts. When used in such combinations the weight ratio of styrene (meth)acrylic copolymer(s) to such conventional dispersants will usually be 16 to 2:1 respectively, and more usually 12 to 4:1, particularly from 10 to 6:1.

The amount of acrylic acid monomer present in the polymeric binder may be in the range from 10 wt. % to 70 wt. %. Preferably, 20 wt. % to 60 wt. %. More preferably from, 25 wt. % to 50 wt. %. Most preferably, from 30 wt. % to 40 wt. %.

The amount of vinyl aromatic monomer present in the polymeric binder may be in the range from 90 wt. % to 30 wt. %. Preferably, 80 wt. % to 40 wt. %. More preferably from, 75 wt. % to 50 wt. %. Most preferably, from 70 wt. % to 60 wt. %.

The pH of the polymeric binder may be in the range from 5 to 10. More preferably, in the range from 6 to 9. Further preferably, in the range from 7 to 9. Most preferably, in the range from 7.5 to 8.5.

The polymeric binder can be made by free radical initiated polymerisation, e.g. using a peroxide or a redox initiator, particularly by solution polymerisation, of the constituent monomers, optionally also with a chain transfer agent such as an alkyl mercaptan which acts to control the molecular weight of the polymer. Suitable methods are described for example in EP 0697422.

The polymeric binder may also be made by a solvent swap method in a hydrophilic solvent mixture, for example IPA/water mix, with addition of monomer feeds with initiator, monomer reacts and then distilled and neutralised simultaneously.

The molecular weight (weight average) of the polymeric binders described herein can be determined by techniques well known in the art such as light scattering, size exclusion HPLC or mass spectrometry, preferably by mass spectrometry.

A “resin” according to the present invention is preferably a rosin resin or rosin ester being any molecule in which at least two rosin acid or rosin acid derivative units are connected by means of at least two ester linkages. Any molecule with at least two hydroxyl groups can be used to provide the ester linkage between at least two rosin acids units. Common examples include, but are not limited to, glycerol esters, pentaerythritol esters and (triethylene) glycol esters.

A “rosin acid” according to the present invention is understood to comprise a mixture of various rosin acid molecules. Mixtures of this kind that are readily available and occur in nature include, but are not limited to, tall oil rosin, gum rosin or wood rosin. These natural mixtures may comprise rosin acids of the abietic type and/or the pimaric type such as abietic acid, palustric acid, neoabietic acid, levopimaric acid, pimaric acid, isopimaric acid or dehydroabietic acid, among others, in varying amounts. In addition to rosin acids with one carboxylic acid functionality, rosin acids with two or more carboxylic acid functionalities are also considered as rosin acids in the meaning of the present invention.

A “rosin acid derivative” according to the present invention is any molecule that has the molecular rosin acid backbone but is modified in at least one of the following ways. In one embodiment, at least one double bond is hydrogenated (hydrogenation). In another embodiment, at least one of the rings of the rosin and backbone is dehydrogenated so that an aromatic ring results (dehydrogenation). In yet another embodiment, adducts to the conjugated double bonds of the rosin acid backbone are included, in particular the addition of maleic anhydride in a Diels-Alder type reaction. The resulting adduct is considered one type of a rosin acid derivative according to the present invention.

The “resin dispersions” according to the present invention are dispersions of rosin resin entities wherein the solvent is generally water or an aqueous solution. However, mixtures of water with a non-aqueous solvent, in particular an organic solvent, would also be suitable as long as the foaming properties or other dispersion properties are not negatively affected. Mixtures of water with other water-soluble solvents could also be used as well.”

Suitably, any rosin resin(s) or any rosin resinous material(s) conventionally used in resin dispersions are suitable for use according to the present invention. For example, suitable classes of resins include rosin esters, rosin resins, pentaerythritol, glycerol, triethylene glycol esters of rosin, or mixtures thereof.

Suitable rosin resins include, but are not limited to esters of natural and modified rosins and the hydrogenated derivatives thereof. Mixtures of two or more of the above-described resins suitably may be used in some embodiments.

Suitably, in other embodiments, the rosin can be an unmodified or a modified rosin. There are many different ways of modifying rosins. For example, the rosin can be esterified. In some embodiments, the rosin is a glycerol, pentaerythritol or triethylene glycol ester of a rosin acid. Suitably, in other embodiments, any low molecular weight compounds containing multiple hydroxyl groups could be used to produce rosin esters.

Rosin resins suitable for the aqueous resin dispersions of the invention include rosin acids and rosin derivatives. Rosin acids are produced from wood, gum or tall oil rosin. Wood rosin is harvested from the stumps of trees. Gum rosin is collected from the sap of trees in regions such as China and Brazil. Tall oil rosin is a by-product of the Kraft paper process. The distribution of rosin acid isomers varies within each of these sources. Rosin acids may be partially or fully hydrogenated or disproportionated.

Rosin derivatives may be dimerised or polymerised from rosin acid. Rosin derivatives also include rosin esters that are the reaction product of rosin acid and a single or multifunctional alcohol. Aromatic and aliphatic alcohols suitable for synthesising rosin esters include, but are not limited to, pentaerythritol, glycerol, triethylene glycol and methanol. Rosin derivatives may be modified with phenol, maleic acid, fumaric acid or other suitable polar compounds. Rosin acids may be partially or fully hydrogenated or disproportionated.

The rosin resin can be characterised by a Ring and Ball softening point ranging from about 10° C. to about 150° C. and have molecular weights from 300-10,000 g/mol. More preferably the resins range in softening point from about 10° C. to about 100° C. and have molecular weights from 300-3,000 g/mol.

Rosin resin dispersions suitable for this invention consist of waterborne dispersions of rosin resins containing 20 to 80% resin, preferably 30 to 70% resin and more preferably 40 to 60% resin.

It will be understood that the seed coating composition could be provided as a combined system with the polymeric binder and/or resin, and hydrolysed protein already combined. In an alternative embodiment, a two component system could be provided which comprises the separate components, these being combinable by an end user to form the seed coating composition. In said alternative embodiment a two part system may be provided comprising a first component being a polymeric binder and/or resin, and a second component being a hydrolysed protein. The two part system being suitable for combining to form a seed coating composition in accordance with the first aspect.

The seed coating composition may also include other components as desired. These other components may be selected from those including:
diluents, absorbents or carriers such as carbon black; talc; diatomaceous earth;
kaolin; aluminium, calcium or magnesium stearate; sodium tripolyphosphate;
sodium tetraborate; sodium sulphate; sodium, aluminium and mixed sodium-aluminium silicates; and sodium benzoate,
wetting agents such as alcohol ethoxylate and alcohol ethoxylate/propoxylate wetting agents;
dispersants such as sulphonated naphthalene formaldehyde condensates and acrylic copolymers such as the comb copolymer having capped polyethylene glycol side chains on a polyacrylic backbone;
emulsifiers such as alcohol ethoxylates, ABA block co polymers, or castor oil ethoxylates;
antifoam agents, e.g. polysiloxane antifoam agents, typically in amounts of 0.005 wt. % to 10 wt. % of the formulation;
waxes such as natural wax, mineral wax and synthetic wax or a combination thereof. Preferably, the wax is selected from the group consisting of polyethylene wax, carnauba wax, paraffin wax, polypropylene wax, oxidised polyethylene wax, montan wax, ceresin wax, ozocerite, peat wax, Fischer Tropsch wax, amide wax, ethylene acrylic acid wax, polyolefin wax, ethylene bis stearamide wax, bees wax, lanolin wax, sugar cane wax, palm wax, and vegetable wax;
viscosity modifiers such as commercially available water soluble or miscible gums, e.g. xanthan gums, and/or cellulosics, e.g. carboxy-methyl, ethyl or propylcellulose; and/or
preservatives and/or anti-microbials such as organic acids, or their esters or salts such as ascorbic e.g. ascorbyl palmitate, sorbic e.g. potassium sorbate, benzoic e.g. benzoic acid and methyl and propyl 4-hydroxybenzoate, propionic e.g. sodium propionate, phenol e.g. sodium 2-phenylphenate; 1,2-benzisothiazolin-3-one; or formaldehyde as such or as paraformaldehyde; or inorganic materials such as sulphurous acid and its salts, typically in amounts of 0.01 wt. % to 1 wt. % of the formulation.

The seed coating composition of the invention may also comprise a surface active agent such as a wetting, dispersing and/or emulsifying agent. The surface active agent may aid in mixing/emulsifying/dispersing the wax and/or pigment particles in the pre-blend and seed coating composition. Suitable surface active agents include ionic and non-ionic products and include solutions of organo-modified polyacrylates, polyacrylates, sodium polyacrylate, polyurethane, phosphoric acid ester, star polymers, and/or modified polyethers.

The seed coating composition of the invention may comprise further components such as one or more selected from a solvent, a thickener, an anti-foaming agent, a preservative, and a slip additive.

Suitable thickeners include agar, carboxy methylcellulose, carrageenan, chitin, fucoidan, ghatti, gum arabic, karaya, laminaran, locust bean gum, pectin, alginate, guar gum, xanthan gum, diutan gum, and tragacanth, bentonite clays, HEUR (hydrophobically modified, ethoxylated urethane) thickeners, HASE (hydrophobically modified, alkali-swellable emulsion) thickeners and polyacrylates. Gums are generally preferred because of their low cost, availability and superior ability to enhance the physical characteristics of the resultant coated film.

Examples of suitable antifoaming agents include polyethylene glycol, glycerine, mineral oil defoamers, silicone defoamers, and non-silicone defoamers (such as polyethers, polyacrylates), dimethylpolysiloxanes (silicone oils), arylalkyl modified polysiloxanes, polyether siloxane copolymer containing fumed silica. The antifoaming agent may be present in some embodiments of the seed coating composition in an amount of at least 1 ppm by weight, or 0.1 to 0.3% by weight based on the total weight of the seed coating composition.

The seed coating composition further may comprise one or more solvents other than water. Solvents may be selected from the group consisting of alcohols, and hydrocarbons. Also mixtures of solvents can be used. It is preferred that the solvent is liquid at 20° C. and 1 atm. Examples of suitable solvents include glycols and their esters and ethers, in particular ethylene and propylene glycols and their esters and ethers, for instance, esters and ethers with C1 C6 alkyl groups and/or aromatic groups, such as methyl, ethyl, propyl, butyl, benzyl and phenyl ethers, including mono ethers and dialkyl ethers, and esters of these ethers, such as acetates, and ethylene and propylene glycol esters, for instance of fatty acids; polyethylene glycol (PEG) and polypropylene glycol and esters thereof, especially with fatty acids; butyl cellosolve, butyl carbitol, polyethylene glycol; N methylpyrrolidone, glycerine, alkyl alcohols with up to 10 carbon atoms, such as ethanol, propanol and butanol. Other examples of solvents include dipropylene glycol methyl ether and propylene glycol methyl ether. An important solvent is ethylene glycol. Further examples include propylene tetramer and synthetic ester oils such as lactate esters, particularly ethyl lactate and benzoate esters e.g. iso-propyl or 2-ethylhexyl benzoates. Aromatic hydrocarbons such as xylene, aliphatic and paraffinic solvents and vegetable oils can also be used as solvent. Aromatic solvents are less preferred.

The seed coating composition may also comprise components with a plasticising effect, such as surfactants or antifreeze agents. Common surfactants include amphiphilic organic compounds, usually comprising a branched, linear or aromatic hydrocarbon, fluorocarbon or siloxane chain as tail and a hydrophilic group. Some types of surfactants include non-ionic, anionic, cationic and amphoteric surfactants, and organosilicone and organofluorine surfactants. Some examples of surfactants include polyoxyethylene glycol and polyoxypropylene ethers and esters, in particular alkyl, aryl and alkylaryl ethers thereof, and sulphates, phosphates and sulphonic acid compounds of such ethers, glucoside (alkyl) ethers, glycerol esters, such as alkyl and fatty acid esters, sorbitan (alkyl) esters, acetylene compounds, cocamide compounds, block copolymers of polyethylene glycol and propylene glycol. Further examples of surfactants include alkylamine salts and alkyl quaternary ammonium salts, for example betaine type surfactants, amino acid type surfactants; and polyhedric alcohols, fatty acid esters, in particular C12 C18 fatty acids, for instance of polyglycerin, pentaerythritol, sorbitol, sorbitan, and sucrose, polyhydric alcohol alkyl ethers, fatty acid alkanol amides, and propoxylated and ethoxylated compounds such as fatty alcohol ethoxylates, polyethyxlated tallow amine and alkylphenol ethoxylates. Some examples of anionic surfactants include carboxylic acids, copolymers of carboxylic acids, sulphates, sulphonic acid compounds and phosphates, for example lignin sulphonates and (linear) alkylaryl sulphonates.

Anti-freeze agents include for example: ethylene glycol, propylene glycol, 1,3 butylene glycol, hexylene glycol, diethylene glycol, and glycerin, with the preferred glycol being ethylene glycol and propylene glycol.

The seed coating composition of the present invention may also contain one or more optional pigments, which function to provide an aesthetic effect when coated on seed. The pigment is preferably an inorganic material and may, for example, be an effect pigment and/or a coloured pigment as known in the art.

Examples of suitable effect pigments include pearlescent pigment in different particle sizes. Effect pigments having a particle size of 60 μm or less, or a particle size of 15 μm or less may be used. The particle size of the effect pigment is preferably not more than 200 μm, more preferably not more than 100 μm. Usually, the particle size of the effect pigment is 1 μm or more. Another effect pigment can be aluminium. Effect pigments can be used to create an attractive cosmetic look on the seeds.

Examples of coloured pigments include pigment red 112 (CAS No. 6535-46-2), pigment red 2 (CAS No. 6041-94-7), pigment red 48:2 (CAS No. 7023-61-2), pigment blue 15:3 (CAS No. 147-14-8), pigment green 36 (CAS No. 14302-13-7), pigment green 7 (CAS No. 1328-53-6), pigment yellow 74 (CAS No. 6358-31-2), pigment orange 5 (CAS No. 3468-63-1), pigment violet 23 (CAS No. 6358-30-1), pigment black 7 (CAS No. 97793 37 8), and pigment white 6 (CAS No. 98084-96-9). The particle size of the coloured pigment is preferably not more than 100 μm, more preferably not more than 50 μm. Usually, the particle size of the coloured pigment is 25 μm or more.

A dye such as anthraquinone, triphenylmethane, phthalocyanine, derivatives thereof, and diazonium salts, may be used in addition to or as an alternative to a coloured pigment.

The amount of pigment in the seed coating composition, if present, is suitably in the range from 0.1 to 15%, preferably 1.0 to 8.0%, more preferably 2.0 to 5.0%, particularly 2.5 to 3.5%, and especially 2.8 to 3.2% by weight based on the total weight of the composition.

A biocide can be included in some embodiments of the seed coating composition for instance as preservative, in order to prolong the shelf life of the seed coating composition before being applied to a seed, such as when being stored. Examples of suitable biocides include MIT (2 methyl 4-isothiazolin-3-one; CAS No. 2682 20-4), BIT (1,2 benzisothiazolin-3-one; CAS No. 2632-33-5)), CIT (5-Chloro-2-methyl-4-isothiazolin-3-one), Bronopol (2-Bromo-2-nitro-propane-1,3-diol) and/or a combination of these.

The seed coating composition may comprise one or more biologically active ingredients (including plant enhancing agents, in particular plant protective products (also referred to as PPPs)). Suitable examples of active ingredients, in particular plant enhancing agents, are fungicidal agents, bactericidal agents, insecticidal agents, nematicidal agents, molluscicidal agents, biologicals, acaricides or miticides, pesticides, and biocides. Further possible active ingredients include disinfectants, micro organisms, rodent killers, weed killers (herbicides), attracting agents, (bird) repellent agents, plant growth regulators (such as gibberellic acid, auxin or cytokinin), nutrients (such a potassium nitrate, magnesium sulphate, iron chelate), plant hormones, minerals, plant extracts, germination stimulants, pheromones, biological preparations, etc.

The amount of active ingredient applied, of course, strongly depends on the type of active ingredient and the type of seed used. Usually, however, the amount of one or more active ingredients is in the range of 0.001 to 200 g per kg of the seed. The skilled person is able to determine suitable amounts of active ingredient depending on the active ingredient and the type of seed used. It is common practice for the skilled person to use and follow the advice of the active ingredient suppliers (e.g., BASF, Bayer, Syngenta, DuPont, etc.), such as by using technical data sheets and/or following recommendations.

Typical fungicidal agents include Captan (N trichloromethyl)thio 4 cyclohexane 1,2-dicarboximide), Thiram tetramethylthioperoxydicarbonic diamide (commercially available as Proseed™), Metalaxyl (methyl N (2,6 dimethylphenyl)-N (methoxyacetyl) d,l-alaninate), Fludioxonil (4 (2,2 difluoro-1,3 benzodioxol-4-yl)-1H pyrrol-3-carbonitril; commercially available in a blend with mefonoxam as Maxim™ XL), difenoconazole (commercially available as Dividend™ 3FS), carbendazim iprodione (commercially available as Rovral™), ipconazole (commercially available as Rancona from Arista, formerly Agriphar or Chemtura), mefonoxam (commercially available as Apron™ XL), tebuconazole, carboxin, thiabendazole, azoxystrobin, prochloraz, prothioconazole (commercially available as Redigo from Bayer), sedaxane (commercially available as Vibrance from Syngenta), cymoxanil (1 (2 cyano-2-methoxyiminoacetyl) 3 ethylurea), fludioxonil, a mixture of metalaxyl, cymoxanil and fludioxonil commercially available as Wakil from Syngenta, and oxadixyl (N (2,6 dimethylphenyl)-2-methoxy-N (2 oxo 3 oxazolidinyl) acetamide). A fungicide can be included in the seed coating composition in an amount of 0.0001 to 10% by total weight of the coated seeds.

Typical bactericidal agents include streptomycin, penicillins, tetracyclines, ampicillin, and oxolinic acid.

Typical insecticidal agents include pyrethroids, organophosphates, caramoyloximes, pyrazoles, amidines, halogenated hydrocarbons, neonicotinoids, and carbamates and derivatives thereof. Particularly suitable classes of insecticides include organophosphates, phenylpyrazoles and pyrethoids. Preferred insecticides are those known as terbufos, chlorpyrifos, fipronil, chlorethoxyfos, tefluthrin, carbofuran, imidacloprid, and tebupirimfos. Commercially available insecticides include imidacloprid (commercially available as Gaucho™), and clothianidin (commercially available from Bayer as Poncho™), thiametoxam (commercially available from Syngenta as Cruiser™), thiacloprid (commercially available as Sonido from Bayer), Cypermetrin (commercially available from Chemtura as Langis™, methiocarb (commercially available as Mesurol from Bayer), fipronil (commercially available from BASF as Regent™), chlorantraniliprole (also known as rynaxypyr, 5-bromo-N-[4-chloro-2-methyl-6 (methylcarbamoyl)phenyl]-2-(3-chloropyridin-2-yl)pyrazole-3 carboxamide, commercially available as Coragen™ from DuPont) and cyantraniliprole (also known as cyazypyr, 3 bromo-1-(3-chloro-2-pyridyl)-4′ cyano-2′-methyl-6′ (methylcarbamoyl)pyrazole-5-carboxanilide).

Commercially available nematicidal agents include abamectin (commercially available from Syngenta as Avicta™) thiodicarb (commercially available from Bayer as Aeris™).

Typical molluscicidal agents include metaldehyde (commercially available from Lonza as Meta™) or niclosamid (commercially available from Bayer as Bayluscide™), Cyazypir and Rynaxypir (available from DuPont).

Examples of suitable biologicals include bacilli, Trichoderma, rhizobia (for nitrogen fixation) and the like, which have been identified as seed treatment materials to protect plants and/or enhance their health and/or productive capacity.

These lists are not exhaustive, new active ingredients are continuously developed and can be incorporated in the seed coating composition.

Nutrients may be present in addition to, or as an alternative to, agrochemical actives. In such formulations the nutrient is typically in a dry form.

The nutrients may preferably be a solid phase nutrients. Solid nutrients are to be understood in the present invention as meaning substances whose melting point is above 20° C. (at standard pressure). Solid nutrients will also include insoluble nutrient ingredients, i.e. nutrient ingredients whose solubility in water is such that a significant solid content exists in the concentrate after addition.

Nutrients refer to chemical elements and compounds which are desired or necessary to promote or improve plant growth. Suitable nutrients generally are described as macronutrients or micronutrients. Suitable nutrients for use in the concentrates according to the invention are all nutrient compounds.

Micronutrients typically refer to trace metals or trace elements, and are often applied in lower doses. Suitable micronutrients include trace elements selected from zinc, boron, chlorine, copper, iron, molybdenum, and manganese. The micronutrients may be in a soluble form or included as insoluble solids, and may be salts or chelated.

Macronutrients typically refer to those comprising nitrogen, phosphorus, and potassium, and include fertilisers such as ammonium sulphate, and water conditioning agents. Suitable macro nutrients include fertilisers and other nitrogen, phosphorus, potassium, calcium, magnesium, sulphur containing compounds, and water conditioning agents.

Suitable fertilisers include inorganic fertilisers that provide nutrients such as nitrogen, phosphorus, potassium or sulphur. Fertilisers may be included in diluted formulations at relatively low concentrations or as more concentrated solutions, which at very high levels may include solid fertiliser as well as solution.

It is envisaged that inclusion of the nutrient would be dependent upon the specific nutrient, and that micronutrients would typically be included at lower concentrations whilst macronutrients would typically be included at higher concentrations.

Biostimulants may enhance metabolic or physiological processes such as respiration, photosynthesis, nucleic acid uptake, ion uptake, nutrient delivery, or a combination thereof. Non-limiting examples of biostimulants include seaweed extracts (e.g., ascophyllum nodosum), humic acids (e.g., potassium humate), fulvic acids, myoinositol, glycine, and combinations thereof.

The hydrolysed protein is suitably present in the seed coating composition at a concentration in the range from 0.5 to 25 wt. %, preferably 2 to 18 wt. %, more preferably 5 to 15 wt. %, in particular 8 to 12 wt. %.

The polymeric binder in the coating composition is suitably present in the amount from 5 to 40%, preferably in the range from 8 to 30%, most preferably in the range from 10 to 25% by weight based on the total weight of polymeric binders present is polyvinylpyrrolidone.

In one embodiment, the coating composition suitably comprises in the range from (i) 60 to 98%, preferably 70 to 95%, more preferably 80 to 92%, particularly 87 to 91%, and especially 88 to 90% by weight of polyvinylpyrrolidone, and (ii) 2 to 40%, preferably 5 to 30%, more preferably 8 to 20%, particularly 9 to 13%, and especially 10 to 12% by weight of polymeric binders other than polyvinylpyrrolidone; both based on the total weight of polymeric binders in the coating composition.

The amount of polymeric binder in the seed coating composition is suitably in the range from 3 to 40%, preferably 6 to 25%, more preferably 8 to 12%, particularly 9.4 to 9.9%, and especially 9.6 to 9.7% by weight based on the total weight of the composition.

In one embodiment, a hydrolysed protein formulation or pre-blend and aqueous binder composition pre-blend are formed separately and then mixed together to form the seed coating composition of the invention. The aqueous composition pre-blend preferably comprises the polymeric binder defined herein. The aqueous composition pre-blend may also comprise pigment, as defined herein, and any of the other optional seed coating composition components defined herein. The aqueous composition pre-blend may also contain one or more of the biologically active materials described herein.

In an alternative embodiment, the composition may be made in a ‘one-pot’ method where all components are added in.

Coating includes film coating, pelleting, and encrusting or a combination of these techniques as known in the art. It is envisaged that the present invention applies to all said coatings types, preferably to film coating.

The seed coating composition of the invention may be applied to the seed in conventional manners.

The seed may be primed or not primed (having been subjected to a treatment to improve the germination rate, e.g. osmopriming, hydropriming, matrix priming).

In one embodiment, the seed is not provided with artificial layers prior to applying the seed coating composition of the invention, for example primer layers comprising a binder, such as a polymer. Accordingly, the seed coating composition is preferably applied directly on the natural outer surface of the seed. Nonetheless, it is possible that the seed surface has undergone a surface treatment prior to applying the seed coating composition.

Preferably, the seed coating composition is applied as a liquid composition and/or emulsion and/or dispersion and/or latex composition and thereafter solidified (including cured and/or dried) to form a seed coating. The term “liquid coating composition” as used in this application is meant to include coating compositions in the form of a suspension, emulsion, and/or dispersion, preferably a dispersion.

Conventional means of coating may be employed for coating the seeds. Various coating machines are available to the person skilled in the art. Some well known techniques include the use of drum coaters, fluidised bed techniques, rotary coaters (with and without integrated drying), and spouted beds. Suitably, the seed coating composition is applied to the seed by a rotary coater, a rotary dry coater, a pan coater or a continuous treater.

Where the seed is encrusted, the amount of water in the seed coating composition is suitably less than 30%, preferably less than 25%, more preferably less than 20%, particularly in the range from 14.0 to 17.0%, and especially 15.0 to 16.0% by weight based on the total weight of the composition.

In an alternative embodiment where the seed is film coated, the amount of water in the seed coating composition is suitably in the range from 20% to 80%, preferably in the range from 30% to 70%, more preferably in the range from 40% to 60% by weight based on the total weight of the composition.

The seed coating composition can, for instance, be applied by film coating, spraying, dipping, or brushing of the seed coating composition. Optionally, it is applied at a temperature of 25° C. to 50° C., for instance 5° C. to 35° C., more often 15° C. to 30° C., for instance at room temperature, such as 18° C. to 25° C. Preferably, the seed coating composition is applied to the seed by film coating. The film coating may suitably be applied by spraying the liquid coating composition onto the seed, typically while the seeds fall or flow through a coating apparatus. Preferably, the method comprises film coating of the seed to apply the seed coating composition in the form of a film coating composition.

Preferably, the method comprises applying the seed coating composition to form an film or seed coating layer.

Seed coating typically involves forming on the surface of the seeds a firmly adhering, moisture permeable coating. The process typically comprises applying a liquid seed coating composition to the seeds before planting.

An additional film coat layer may optionally be applied over the top of the coating, layer of the invention to provide additional benefits, including but not limited to cosmetics, coverage, actives, nutrients, and processing improvements such as faster drying, seed flow, durability and the like.

All of the features described herein may be combined with any of the above aspects, in any combination.

### EXAMPLES

In order that the present invention may be more readily understood, reference will now be made, by way of example, to the following description.

It will be understood that all tests and physical properties listed have been determined at atmospheric pressure and room temperature (i.e. 25° C.), unless otherwise stated herein, or unless otherwise stated in the referenced test methods and procedures.

The following test methods were used to determine performance of the drought resistance additives.

Moisture Stress Test on Paper

Evaluation of the hydrolysed protein products was done using various germination testing methods. Germination testing on paper was done in moisture stress testing in which the density of water was manipulated via PEG (Polyethylene Glycol).

To test the abiotic stress factor of reduced moisture availability a moisture stress test on paper was performed on the objects. The moisture stress test consisted of performing a germination test with moisture stress controlled via Polyethylene Glycol (PEG). Lighting in combination with a solution of PEG has a negative effect on plant development. All PEG testing was done in a phytotron with a 9-hour long light and 15-hour dark cycle with a white paper sheet on top of the germination containers to shield the plants from direct light. Germinating with no light will result in elongated plants.

An assessment method as shown in Table 1 was used to classify plant development. The classification was used to indicate leaf development after germination, with A class representing good development down to D representing poor development.

TABLE 1
Classification in altered assessment method of corn

| Class | Criteria |
|---|---|
| Greentip visible from coleoptile | Greentip from coleoptile visible from |
| | tip/beginning of coleoptile |
| A class | Stem, cotyle, leaf >4 cm above fold |
| B class | Stem, cotyle, leaf 2-4 cm above fold |
| C class | Stem, cotyle, leaf <2 cm above fold |
| D class | Germinated but below fold |

Evaluation of Sunflower objects was done via root length measurement.

Moisture Stress Test in Soil

Three sowings were done per object; the tray was filled with 60 cc potting soil, 25 wheat seeds sown, and covered with 30 cc of potting soil. Watering of 100 cc water was done after sowing. Irrigation was done every 3, 7, and 14 days, depending on the object. In comparison with the corn moisture stress testing the difference in plant development could not be expressed with length measurements or green tip count.

An identification of wheat plant development stage was developed and is shown in Table 2, where stage 2 shows good development and therefore good moisture stress resistance, and stage 0 shows poor development and therefore poor moisture stress resistance.

TABLE 2
Stage description used in assessment of stress test in soil

| Stage | Description of stage |
|---|---|
| Stage 2 | true leaves open and spread (third leaf clearly uncurled) |
| Stage 1 | True leaves still curled/rolled together but showing |
| Stage 0 | very small with no true leaves showing |

Moisture and Salinity Stress Test in Soil

Salinity testing was done with wheat objects. The thermo-gradient table was filled with 5000 cc of potting soil (nutrient rich). 100 g per object was sown per block. Each block covered ⅓ of the thermo-gradient table, covering the full temperature range from 15 to 35° C. The seedbed was covered with 1,000 cc of potted soil.

The thermo-gradient caused moisture to evaporate at a rate which correlates with the gradient of temperature. With that, a gradient of drought was created overall. In the first two weeks the complete table was watered twice with 5 litres of a 0.01 M NaCl solution followed by a weekly watering for 5 weeks with 5 litres 0.4 M NaCl solution (sea water is 0.6 M NaCl). Evaluation was done by visual observation.

Testing was performed on seeds from sunflower, corn, wheat, lettuce and onion. These seeds were coated with film coats enriched with hydrolysed protein products which where synthetic or derived from organic matter of pea, potato, soybean, cotton or wheat. The type of moisture stress test varied per crop.

Materials

The effect of hydrolysed proteins was evaluated, amongst others, on corn, sunflower and wheat. With this selection of crops, a broad representation of different seeds and plant types was taken into account.

The tested objects and the origin of hydrolysed protein used in the additive are listed below.

Tested Hydrolyse Protein Products:
Additive 1 (A1)—hydrolysed wheat protein
Additive 2 (A2)—hydrolysed pea protein
Additive 3 (A3)—hydrolysed potato protein
Additive 4 (A4)—hydrolysed soybean protein
Additive 5 (A5)—hydrolysed cotton protein

The application of the hydrolysed proteins on seeds was done via filmcoat which varied per crop. The hydrolysed proteins were added to commercially available filmcoats during mixing, resulting in a filmcoat “composition” which consisted for 10% out of hydrolysed proteins, in future reference this composition is referred to as filmcoat. Before application on seeds the filmcoats were diluted with water resulting in a filmcoat/water ratio 50/50 varying slightly per crop.

Drought Resistance Results

In Table 3 the total germ count is not affected by the film coat or the addition of hydrolysed proteins. The percentage of green tips from coleoptile is positively affected by the addition of hydrolysed proteins. This indicates that under the moisture stress, induced at a density of 1.024, the development of the seedling/plant is less negatively affected when the seeds are coated with a hydrolysed protein incorporated film coat.

TABLE 3
Results in corn under moisture stress conditions

| | A % | B % | C % | % Green tip |
|---|---|---|---|---|
| Untreated corn seeds | 0 | 10 | 88 | 51 |
| Control treatment | 0 | 8 | 92 | 46 |
| A1 | 0 | 14 | 80 | 63 |
| A2 | 2 | 14 | 82 | 76 |
| A3 | 0 | 10 | 90 | 72 |
| A4 | 0 | 30 | 70 | 84 |
| A5 | 0 | 0 | 98 | 64 |

Plant stage evaluation of corn 14 days after sowing, with moisture density 1.024, classification using Table 1.

Similar results in drought resistance in general germination performance were also seen for sunflower seeds and shown in Table 4.

TABLE 4
Germination performance under osmotic pressure drought stress

| | Average usable plants 10 days after sowing |
|---|---|
| Control filmcoated | 0 |
| A1 | 86 |

Plant stage evaluation of sunflower seed germination on paper 14 days after sowing, with moisture density 1.008.

Moisture Stress Testing Wheat in Soil

Regulated drought stress test in soil was performed on wheat. The stages presented in Table 2 were used to describe the results as shown in Table 5. Initial results showed different reactions per used hydrolysed protein mostly in the general plant development.

The results presented in Table 5 show, that the interval of irrigation affects the development of the plants. The overall germination is not affected by the drought as all objects received the same amount of starting water. The untreated wheat object seems to be consistent in plant development, demonstrating a lesser or no negative reaction to the absence of moisture (i.e. where irrigation is poor) in comparison to the filmcoated control object.

TABLE 5
Results with wheat on soil with irrigation
interval of 100 cc per 14 days

| | % Stage 2 | % Stage 1 | % Stage 0 |
|---|---|---|---|
| Filmcoated control | 32 | 56 | 8 |
| A2 | 60 | 40 | 0 |
| A3 | 52 | 44 | 0 |
| A4 | 52 | 48 | 0 |

Salinity Resistance

Results were obtained via the method described above. Table 6 shows the percentage usable wheat plants under saline conditions.

TABLE 6
Usable wheat plants under saline conditions

| | Usable plants 35 days | Usable plants 49 days |
|---|---|---|
| | after sowing (%) | after sowing (%) |
| Control filmcoated | 5 | 3 |
| A1 | 30 | 25 |
| A2 | 70 | 65 |

Wheat plant evaluation on potted soil irrigated with 0.4M NaCl.

The results in Table 6 show a very clear and significant improvement in salinity resistance for the coatings of the present invention.

Positive effect on growth and plant development could be seen in moisture stress testing on corn, coated with all hydrolysed proteins, regulated moisture plant type testing on wheat, coated with all hydrolysed proteins, and plant type testing on a thermogradient table show similar positive effects. In general, a positive effect caused by the drought resistance additive on young plant development is seen under drought stress, thereby demonstrating improved drought stress tolerance.

It is to be understood that the invention is not to be limited to the details of the above embodiments, which are described by way of example only. Many variations are possible.

1. A seed coating composition comprising a polymeric binder and/or resin, and a hydrolysed protein.

2. The composition according to claim 1, wherein the hydrolysed protein present is derived from either animal or vegetable sources, or by fermentation.

3. The composition according to claim 1, wherein the hydrolysed protein comprises amino acid chains formed from hydrolysing a protein.

4. The composition according to claim 1, wherein the hydrolysed protein is hydrolysed wheat protein produced by enzyme hydrolysis.

5. The composition according to claim 1, wherein the molecular weight (weight average) of the hydrolysed protein is in the range from 50 Da to 50,000 Da.

6. The composition according to claim 1, wherein the hydrolysed protein comprises on average in the range from 2 to 15 amino acids.

7. The composition according to claim 1, wherein the amount of free amino acid in the hydrolysed protein is less than 60 wt. %.

8. The composition according to claim 1, wherein the polymeric binder is selected from the group consisting of polyvinyl acetates, polyvinyl acetate copolymers, polyvinyl alcohols, polyvinyl alcohol copolymers, polyurethane, celluloses (including ethylcelluloses, methylcelluloses, hydroxymethylcelluloses, hydroxypropylcelluloses, carboxymethylcelluloses, and hydroxymethylpropyl celluloses), polyvinylpyrrolidones, dextrins, maltodextrins, starchs, polysaccharides, fats, oils, proteins, gum arabics, shellacs, vinylidene chloride, vinylidene chloride copolymers, calcium lignosulphonates, polyacrylates, acrylic copolymers, polyvinylacrylates, zeins, casein, gelatine, chitosan, pullulan, polyethylene oxide, polyethylene glycol, acrylamide polymers, acrylamide copolymers, polyhydroxyethyl acrylate, methylacrylamide polymers, poly(N vinylacetamide), sodium alginate, polychloroprene, and syrups.

9. The composition according to claim 8, wherein the polymeric binder is selected from the group consisting of polyvinyl acetates, polyvinyl alcohols, hydroxypropylmethylcellulose, polysaccharides (other than starch), proteins, polyethylene glycol, polyvinyl pyrrolidones, and polyacrylates.

10. The composition according to claim 1, wherein the polymeric binder has a molecular weight (weight average) in the range from 1,000 to 40,000.

11. The composition according to claim 1, wherein the polymeric binder is a copolymer of acrylic acid with alkyl methacrylates or styrene with a molecular weight of less than 20,000, and a Tg of more than 30° C.

12. The composition according to claim 1, wherein the resin is a rosin resin or rosin ester.

13. A method of forming a seed coating composition which comprises combining an aqueous composition pre-blend comprising a polymeric binder and/or resin, and a hydrolysed protein pre-blend.

14. A method of coating seed which comprises applying a seed coating composition comprising a polymeric binder and/or resin, and a hydrolysed protein, to a seed.

15. A seed with a coating comprising the composition according to claim 1.

16. The coated seed according to claim 15, wherein the seed is selected from the group consisting of corn, sunflower, wheat, lettuce, and onions.

17. A method for increasing drought and salinity resistance of a seed which comprises coating the seed with the composition according to claim 1.

18. The method according to claim 17, wherein a plant formed from a seed coated with the composition also has increased drought and salinity resistance.

19. A two component system comprising a first component comprising a polymeric binder and/or resin, and a second component comprising a hydrolysed protein, suitable for combining to form a seed coating composition in accordance with claim 1.
